(19) United States
(12) Patent Application Publication
(10) Pub. No.: US 2014/0098962 A1
(43) Pub. Date: Apr. 10, 2014

(54) Angle-dependent operating device or method for generating a pseudo-stereophonic audio signal

(71) Applicant: Stormingswiss GmbH, (unknown)

(72) Inventor: Clemens Par, Cinuos-chel (CH)

(73) Assignee: Stormingswiss GmbH

(21) Appl. No.: 14/100,420

(22) Filed: Dec. 9, 2013

Related U.S. Application Data
(63) Continuation of application No. 12/946,008, filed on Nov. 15, 2010, now Pat. No. 8,638,947.
Application No. 12/946,008 is a continuation of application No. PCT/EP2009/003339, filed on May 12, 2009.

(30) Foreign Application Priority Data
May 13, 2008 (EP) 08008832

(51) Int. Cl. H04S 5/00

(52) U.S. Cl. CPC H04S 5/00
USPC 381/17

(57) ABSTRACT

An apparatus for stereophonizing a mono signal, comprising a convener for converting the mono signal into a principal signal and a side signal by delaying and amplifying the mono signal on the basis of an angle φ between sound source and microphone principal axis.

### REFERENCE DATA

The present application is a continuation of U.S. patent application Ser. No. 12/946,008 (US2011/0075850), the contents of which are hereby incorporated, and which is a continuation of international PCT application PCT/EP2009/00339 (WO2009/138205) filed on May 12, 2009, the contents of which are hereby incorporated, and which claims priority from European patent application EP08008832 of May 13, 2008, the contents whereof are hereby incorporated.

### TECHNICAL FIELD

The invention relates to audio signals (particularly sound transducer signals) and to apparatuses and methods for the obtainment, transmission, transformation and reproduction thereof.

### BACKGROUND OF THE INVENTION

Generally, such systems attempt to depict or suggest three-dimensional information which the human ear is able to break down. This can be achieved by the reproduction of two or more differently constituted final signals, by the addition of artificial early reflections or artificial diffuse sound or by the simulation of audio circumstances relating to the human head by means of HRTF, alternatively. These approaches to a solution are used particularly in order to convert monophonic audio signals into audio signals which convey to the ear an actual or fictitious three-dimensionality. Such methods are referred to as “pseudo-stereophonic”.

In comparison with conventional stereo signals, pseudo-stereophonic signals usually exhibit deficiencies. In particular, physico-acoustic reasons mean that the localizability of the sound sources, for example in the case of methods which distribute the frequency spectrum with different phase shifts over the final signals, is restricted. The application of propagation time differences also normally results in inconsistent localization for the same reasons. Artificial reverberation, likewise for physico-acoustic reasons, prompts fatigue phenomena in the listener. A series of proposals have been made, particularly by Gerzon (see below), which are intended to eliminate such inconsistencies in the stereophonic depiction of sound sources. Reproduction of the original three-dimensional circumstances, as conventional stereo signals aim to depict, does not usually occur even in complex applications, however.

In particular, pseudo-stereophony based on the simulation of intensity-stereophonic methods has the particular problem that a monophonic audio signal based on a figure-of-eight directivity pattern cannot be stereophonized, on account of the nondepiction of sound which is incident from the side.

The prior art is formed by the following documents:

U.S. Pat. No. 5,173,944 considers signals, obtained at constant azimuth of 90 degrees, 120 degrees, 240 degrees and 270 degrees by means of HRTF from the differently delayed but uniformly amplified fundamental signal, which are overlaid on the fundamental signal. In this case, level and propagation time corrections remain independent of the original recording situation.

U.S. Pat. No. 6,636,608 proposes phase shifts, determined on the basis of frequency, in the mono signal to be stereophonized which are overlaid on the original monophonic audio signal both in the left-hand and in the right-hand channel with different gains—which are likewise independent of the recording situation!

The aforementioned document U.S. Pat. No. 5,671,287 (Gerzon) improves a method proposed by Orban (which takes a monophonic audio signal and obtains a summed signal and a difference signal which have frequency-dependent phase shifts—regardless of the recording situation!), these improvements likewise being based on frequency-dependent phase shifts or on a gain—regardless of the recording situation!—given slightly altered formation of the summed and difference signals.

The applicant's own European application No. 06008455.5 proposes methodical consideration of the manually or metrologically ascertained angle φ between principal axis and sound source using propagation time and level differences which are dependent on the angle φ. If the angle φ is equal to zero, however, compatible stereophonic depiction is not possible.

The invention explained below is intended to be a significant improvement in the stereophonic reproduction of a monophonic depicted sound source, taking account of the recording situation. In addition, a reliable method of stereophonization is intended to be provided for the aforementioned figure-of-eight directivity pattern, which has to date been problematical for intensity-stereophonic simulations. Subsequently, the aim is to allow compatible stereophonic depiction even for the case in which the angle φ between principal axis and sound source is equal to zero.

The subject matter of the invention can be presented as follows:

The technical solution—proposed in the applicant's own European application No. 06008455.5—of methodical consideration of the angle φ between principal axis and sound source using propagation time and level differences which are dependent on the angle φ involves MS matrixing, where the following relationships apply to input signals M and S and resultant signals L and R:

$$\begin{matrix}L = ( M + S ) * \frac{1}{\sqrt{2}} & ( 1 ) \\ R = ( M - S ) * \frac{1}{\sqrt{2}} & ( 2 )\end{matrix}$$

The classic S signal—which is specific to MS engineering—has a figure-of-eight directivity pattern, said signal being offset from the M signal by 90 degrees to the left. If the level of the S signal is now increased in comparison with the M signal, what is known as the opening angle 2α (which is obtained from the points of intersection of the overlapping polar diagrams for the M system and the S system and—like the figure-of-eight directivity pattern of the S system—is always situated symmetrically with respect to the principal axis of the M signal) is reduced to an increasing extent.

In a first step, it is possible to parameterize a fictitious opening angle 2α even in an arrangement or a method which takes account of the angle φ between the principal axis of the monophonic signal and the sound source. The calculated simulated side signal is then dependent both on the angle φ and on half the fictitious opening angle α.

In a second step, gain factors are applied only to the signals which produce the side signal when summed.

In a third step, the angle-dependent polar interval f describing the directivity pattern of the M signal is parameterized. It is therefore now possible to stereophonize monophonic signals of arbitrary directivity pattern taking account of a fictitious opening angle 2α.

### DISCLOSURE OF THE INVENTION

One embodiment involves the parameterization of a fictitious opening angle α+β. In this case, α is the fictitious left-hand opening angle (situated to the left of the principal axis of the monophonic audio signal to be stereophonized), β is the fictitious right-hand opening angle (situated to the right of the principal axis of the monophonic audio signal to be stereophonized), where it may be that α≠β. Thus, we are looking at the case—which does not arise in classic MS matrixing—of possible fictitious opening angles α+β which are asymmetric with respect to the principal axis of the monophonic audio signal to be stereophonized.

Accordingly, the trigonometrically ascertained level and propagation time differences for the simulated side signal are made dependent not only on φ and f but also on the fictitious left-hand opening angle α and on the fictitious right-hand opening angle β, wherein—if the sound source can be classified as being to the left of the principal axis—the relationship φ≦α must apply or—if the sound source can be classified as being to the right of the principal axis—the relationship φ≦β must apply. In all cases, zero or a region around zero must be ruled out for α and β, since the level and propagation time differences calculated by parameterizing α and β converge toward infinity, that is to say are technically infeasible.

Suitable selection of α and β can therefore be used to attain stereophonic depiction of a monophonic audio signal, which usually affords more favorable conditions than methods which omit parameterization of a fictitious opening angle α and β. In particular, a compatible stereophonic resolution is also possible for the case in which φ is equal to zero. α and β can be chosen as desired subject to the above conditions or can be determined by a suitable algorithm as appropriate.

Trigonometrically, the following delay times L(α), L(β) and gain factors P(α), P(β) (which, in order to allow unrestricted selection of φ, f and α and β, can be applied to the signals S(α) and S(β) which produce the simulated side signal S) are obtained for the angle φ, the angle-dependent polar interval f describing the directivity pattern of the M signal and the angles α and β:

$$\begin{matrix}{L}_{α} = - \frac{f ( α )}{2 sin α} + \sqrt{\frac{{f}^{2} ( α )}{4 {sin}^{2} α} + {f}^{2} ( ϕ ) - \frac{f ( α )}{sin α} * f ( ϕ ) * sin ϕ} & ( 3 ) \\ {L}_{β} = - \frac{f ( β )}{2 sin β} + \sqrt{\frac{{f}^{2} ( β )}{4 {sin}^{2} β} + {f}^{2} ( ϕ ) + \frac{f ( β )}{sin β} * f ( ϕ ) * sin ϕ} & ( 4 ) \\ {P}_{α} = \frac{{f}^{2} ( α )}{4 {sin}^{2} α} + {f}^{2} ( ϕ ) - \frac{f ( α )}{sin α} * f ( ϕ ) * sin ϕ & ( 5 ) \\ {P}_{β} = \frac{{f}^{2} ( β )}{4 {sin}^{2} β} + {f}^{2} ( ϕ ) + \frac{f ( β )}{sin β} * f ( ϕ ) * sin ϕ & ( 6 )\end{matrix}$$

A simplification for apparatuses and methods which make use of the subject matter of the embodiment is the suggestion that the discriminants of L(α) and L(β) can be used directly for ascertaining P(α) and P(β). This significantly simplifies schematic diagrams and algorithms, which means miniaturization of the relevant hardware at the highest efficiency.

Particularly for the aforementioned problems of stereophonization of a monophonic audio signal with a figure-of-eight directivity pattern, the following solution is derived, on the basis of the polar interval f(Ψ)=cosΨ, which describes the figure-of-eight directivity pattern of the M signal and which is dependent on the polar angle Ψ:

$$\begin{matrix}{L}_{α} = - \frac{cos α}{2 sin α} + \sqrt{\frac{{cos}^{2} α}{4 {sin}^{2} α} + {cos}^{2} ϕ - \frac{cos α}{sin α} * cos ϕ * sin ϕ} & ( 7 ) \\ {L}_{β} = - \frac{cos β}{2 sin β} + \sqrt{\frac{{cos}^{2} β}{4 {sin}^{2} β} + {cos}^{2} ϕ + \frac{cos β}{sin β} * cos ϕ * sin ϕ} & ( 8 ) \\ {P}_{α} = \frac{{cos}^{2} α}{4 {sin}^{2} α} + {cos}^{2} ϕ - \frac{cos α}{sin α} * cos ϕ * sin ϕ & ( 9 ) \\ {P}_{β} = \frac{{cos}^{2} β}{4 {sin}^{2} β} + {cos}^{2} ϕ + \frac{cos β}{sin β} * cos ϕ * sin ϕ & ( 10 )\end{matrix}$$

For the subject matter of the embodiment, it remains characteristic that the resultant MS signals finally need to be subjected to stereo conversion in accordance with formulae (1) and (2). A classic stereo signal is the result.

With the inclusion of apparatuses and methods which represent the prior art, it is otherwise possible to use the subject matter of the embodiment to obtain signals which provide stereophonic information via more than two loudspeakers (such as the surround-sound systems which are part of the prior art).

### BRIEF DESCRIPTION OF THE FIGURES

Embodiments and exemplary applications of the present invention are explained by way of example with reference to the following figures:

FIG. 1 shows the operating principle of one embodiment.

FIG. 2 shows a circuit of an embodiment which converts a monophonic audio signal into MS signals which can be stereophonized.

FIG. 3 depicts the internal signals in the circuit shown in FIG. 2.

FIG. 4 shows a classic MS arrangement for the half opening angle α=135 degrees, comprising an M system with a cardioid directivity pattern and an S system with a figure-of-eight pattern.

FIG. 5 shows a classic MS arrangement for the half opening angle α=90 degrees, comprising an M system with an omnidirectional directivity pattern and an S system with a figure-of-eight directivity pattern.

FIG. 6 shows a classic MS arrangement for the half opening angle α=53 degrees, comprising an M system with a cardioid directivity pattern and an S system with a figure-of-eight directivity pattern.

FIG. 7 shows a classic MS arrangement for the half opening angle α=45 degrees, comprising an M system with a figure-of-eight directivity pattern and an S system with a figure-of-eight directivity pattern.

FIG. 8 shows a classic MS arrangement for the half opening angle α=33.5 degrees, likewise comprising an M system with a figure-of-eight directivity pattern and an S system with a figure-of-eight directivity pattern.

FIG. 9 shows an extension of the operating principle of FIG. 1 in which a fictitious half opening angle α is also taken into account.

FIG. 10 shows a circuit which converts a monophonic audio signal into MS signals, which can be stereophonized, taking account of a fictitious half opening angle α.

FIG. 11 shows an example of the operating principle of an embodiment for a signal with an omnidirectional directivity pattern which also takes account of a left-hand fictitious opening angle α and a right-hand fictitious opening angle β, which cannot arise in a classic MS arrangement on account of the use of a system with 90 degrees rotation to the left which is symmetrical with respect to the principal axis and which has a figure-of-eight directivity pattern for the S signal.

FIG. 12 shows an example of the operating principle of an embodiment for a signal having a cardioid pattern.

FIG. 13 shows an example of the operating principle of an embodiment for a signal having a hypercardioid pattern.

FIG. 14 shows an example of the operating principle of an embodiment for a signal having a figure-of-eight directivity pattern.

FIG. 15 shows a circuit based on an embodiment which takes account of the recording angle φ, of a left-hand fictitious opening angle α, of a right-hand fictitious opening angle β and of an angle-dependent polar interval f describing the directivity pattern of the M signal in order to convert a monophonic audio signal into MS signals which can be stereophonized.

FIG. 16 shows a variant for the circuit in FIG. 15, wherein for the recording angle φ, the left-hand fictitious opening angle α and the angle-dependent polar interval f describing the directivity pattern of the M signal it must be true that the expression

$$\frac{{f}^{2} ( α )}{4 {sin}^{2} α} + {f}^{2} ( ϕ ) - \frac{f ( α )}{sin α} * f ( ϕ ) * sin ϕ \qquad ( 11 )$$

is not equal to zero or an element of a region around zero.

FIG. 17 shows a further variant for the circuit in FIG. 15, wherein for the recording angle φ, the right-hand fictitious opening angle β and the angle-dependent polar interval f describing the directivity pattern of the M signal it must be true that the expression

$$\frac{{f}^{2} ( β )}{4 {sin}^{2} β} + {f}^{2} ( ϕ ) + \frac{f ( β )}{sin β} * f ( ϕ ) * sin ϕ \qquad ( 12 )$$

is not equal to zero or an element of a region around zero.

FIG. 18 shows the parameters tᵢ, Pᵢ(tᵢ) from FIG. 19.

FIGS. 19.1 and 19.2 (referred to collectively as FIG. 19) show the flowchart for a method based on the subject matter of an embodiment which takes account of the recording angle φ, of a left-hand fictitious opening angle α, of a right-hand fictitious opening angle β and of an angle-dependent polar interval f describing the directivity pattern of the M signal, given sufficiently small intervals [tᵢ, tᵢ₊₁],

in order to convert a monophonic audio signal into MS signals which can be stereophonized.

### DETAILED EMBODIMENTS AND EXEMPLARY APPLICATIONS OF THE INVENTION

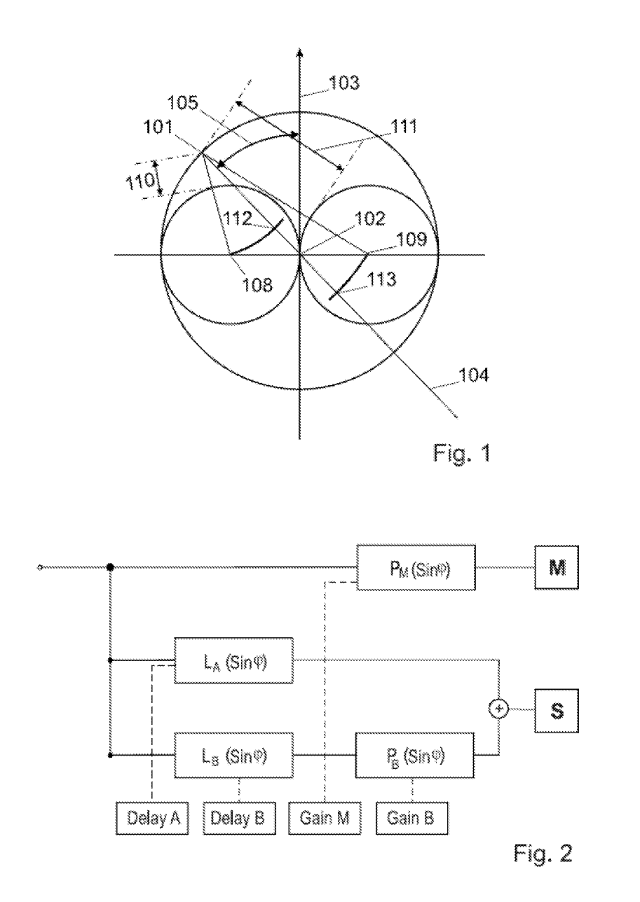

One embodiment for the operating principle of an apparatus or a method for stereophonizing a monophonic signal having an omnidirectional directivity pattern is outlined in FIG. 1: a sound source 101 is recorded beneath position 102 by a microphone having an omnidirectional directivity pattern, with the principal axis 103 and the directional axis 104 of the sound source forming the angle φ (105). 108 and 109 illustrate the geometric positioning of those two simulated signals which produce the simulated side signal when summed. The propagation time difference in comparison with the principal signal for the simulated left-hand signal is 110, and the level of the simulated signal is ascertained from the level of the principal signal, multiplied by the square of the distance from 101 and 112 (level correction taking account of the sound intensity, which decreases as the distance is squared). The propagation time difference in comparison with the principal signal for the simulated right-hand signal is 111, and the level of the simulated signal is ascertained from the level of the principal signal, multiplied by the square of the distance from 101 and 113.

Reweighting the levels, which involves the input signal being associated directly with the simulated left-hand signal, produces the circuit diagram in FIG. 2 for a circuit which converts a monophonic input signal into MS signals which can be stereophonized. Ascertained trigonometrically, the following are obtained in this case for the propagation time differences L_{A} and L_{B} and the gain factors P_{A} and P_{M}:

$$\begin{matrix}{L}_{A} = \sqrt{\frac{5}{4} - sin ϕ - \frac{1}{2}} & ( 13 ) \\ {L}_{B} = \sqrt{\frac{5}{4} + sin ϕ - \frac{1}{2}} & ( 14 ) \\ {P}_{M} = \frac{1}{\frac{5}{4} - sin ϕ} & ( 15 ) \\ {P}_{B} = \frac{\frac{5}{4} + sin ϕ}{\frac{5}{4} - sin ϕ} & ( 16 )\end{matrix}$$

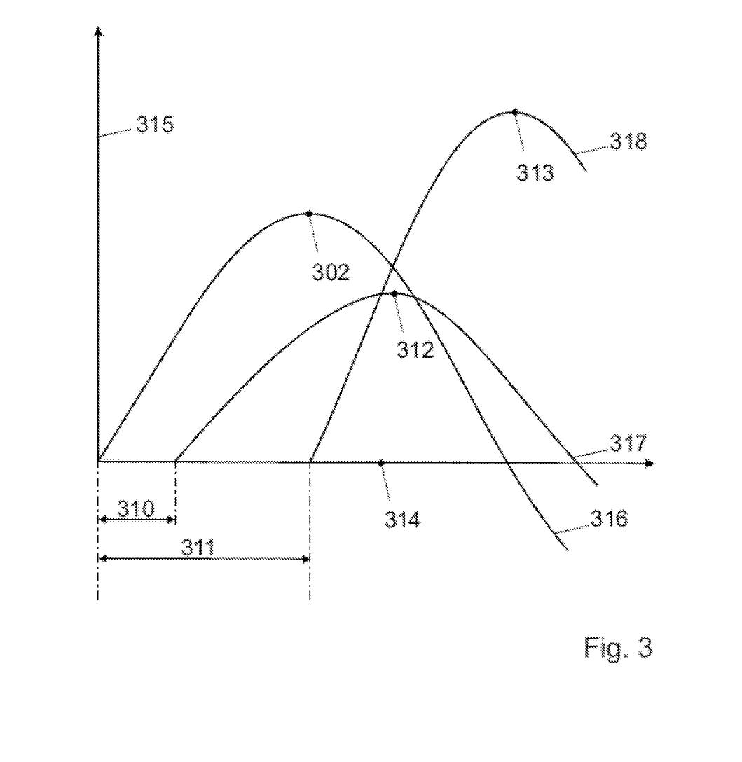

The nature of the internally processed signals is shown in FIG. 3. The principal signal 316 is contrasted therein by two simulated signals 317 (with the delay time 310) and 318 (with the delay time 311) (where 314 is the time axis and 315 is the level axis). The maximum level point 302 is calculated from the maximum level point 312 on the basis of formula (15), and the maximum level point 313 is calculated on the basis of formula (16).

In order to derive apparatuses or methods operating on the basis of angle for the purpose of obtaining a pseudostereophonic audio signal, first of all the classic MS matrixing is considered for various half opening angles 2α and various directivity patterns of the M system. The symmetry of the S system with 90-degree rotation to the left with respect to the principal axis of the M system means that an inherent feature of all methods is an opening angle 2α which is likewise arranged symmetrically with respect to the principal axis and which is calculated from the points of intersection of the overlapping polar diagrams of the M system and the S system.

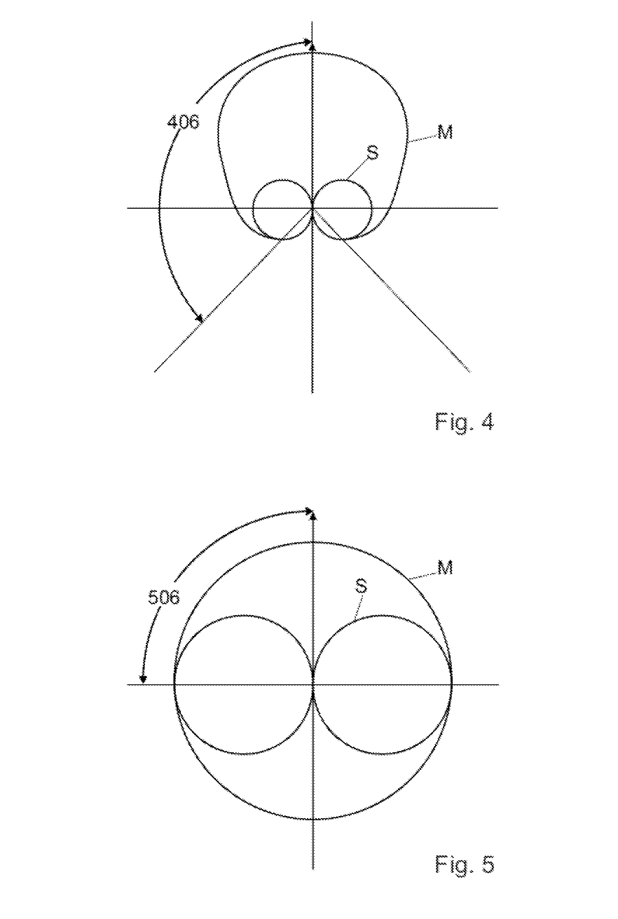

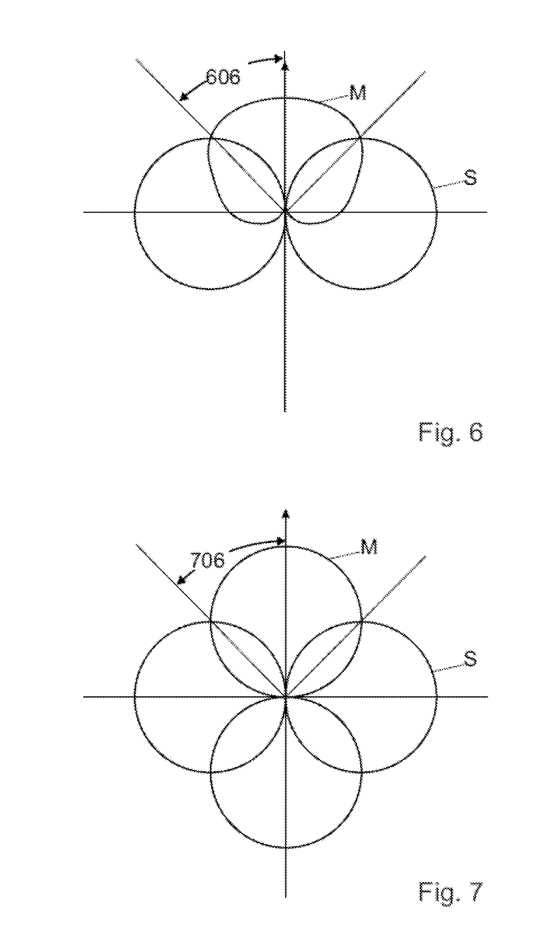

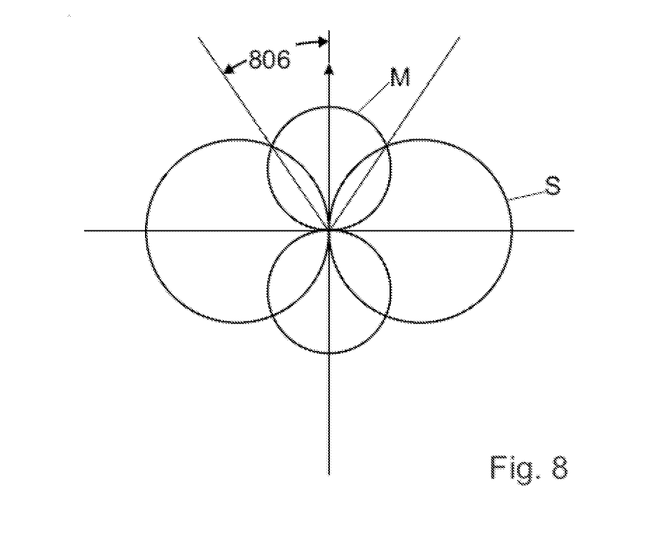

Thus, by way of example, FIG. 4 shows a classic MS arrangement for the half opening angle α (406) equal to 135 degrees, comprising an M system having a cardioid directivity pattern and an S system having a figure-of-eight directivity pattern. FIG. 5 shows a classic MS arrangement for the half opening angle α (506) equal to 90 degrees, comprising an M system having an omnidirectional directivity pattern and an S system having a figure-of-eight directivity pattern. FIG. 6 shows a classic MS arrangement for the half opening angle α (606) equals 53 degrees, comprising an M system having a cardioid directivity pattern and an S system having a figure-of-eight directivity pattern. FIG. 7 shows a classic MS arrangement for the half opening angle α (706) equals 45 degrees, comprising an M system having a figure-of-eight directivity pattern and an S system having a figure-of-eight directivity pattern. FIG. 8 shows a classic MS arrangement for the half opening angle α(806) equals 33.5 degrees, likewise comprising an M system having a figure-of-eight directivity pattern and an S system having a figure-of-eight directivity pattern.

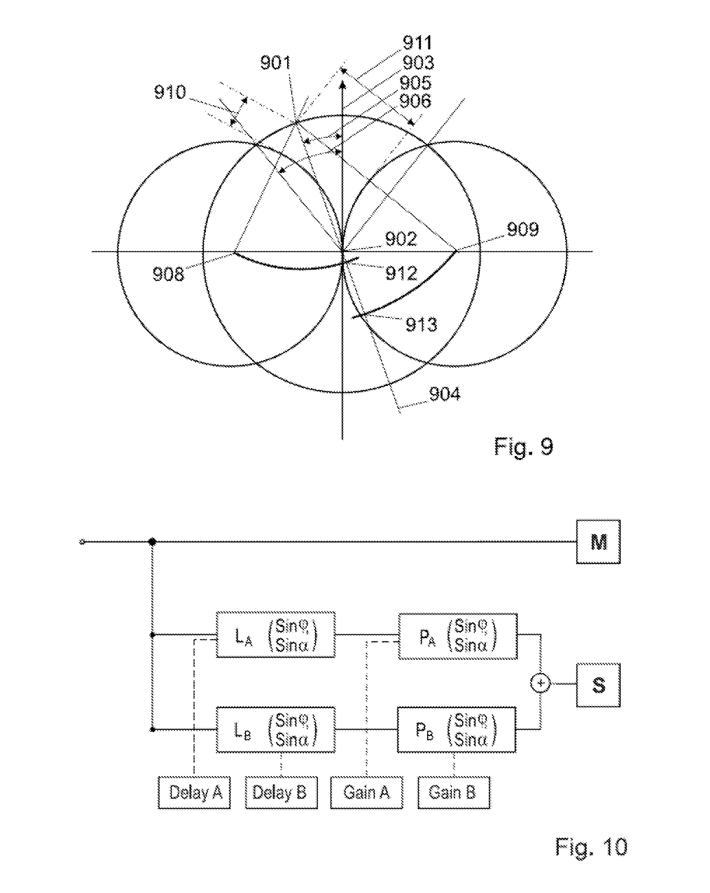

An extension of the operating principle derived from FIG. 1 is the additional consideration of a fictitious half opening angle α, as shown in FIG. 9: in this case, a sound source 901 is recorded by a mono microphone 902 having an omnidirectional directivity pattern, where the principal axis 903 and the directional axis 904 of the sound source form the angle φ (905). Fresh consideration is given to the fictitious half opening angle α (906). This and the directivity pattern of the principal signal are used to directly derive the geometric positioning 908 of the simulated left-hand signal S_{A} and the geometric positioning 909 of the simulated right-hand signal S_{B}, which produce the simulated side signal when summed. The propagation time difference in comparison with the principal signal for the simulated left-hand signal is 910, and the level of the simulated signal is ascertained from the level of the principal signal, multiplied by the square of the distance from 901 and 912 (level correction taking account of the sound intensity, which decreases as the distance is squared). The propagation time difference in comparison with the principal signal for the simulated right-hand signal is 911, and the level of the simulated signal is ascertained from the level of the principal signal, multiplied by the square of the distance from 901 and 913.

The associated circuit, which has been slightly modified in comparison with the circuit in FIG. 2, is provided by FIG. 10, which takes account of the fictitious half opening angle α in order to convert a monophonic audio signal into MS signals which can be stereophonized. In this case, the following relationships apply to the propagation time differences L_{A} and L_{B} and the gain factors P_{A} and P_{B}:

$$\begin{matrix}{L}_{A} = - \frac{1}{2 sin α} + \sqrt{\frac{1}{4 {sin}^{2} α} + 1 - \frac{sin ϕ}{sin α}} & ( 17 ) \\ {L}_{B} = - \frac{1}{2 sin α} + \sqrt{\frac{1}{4 {sin}^{2} α} + 1 + \frac{sin ϕ}{sin α}} & ( 18 ) \\ {P}_{A} = \frac{1}{4 {sin}^{2} α} + 1 - \frac{sin ϕ}{sin α} & ( 19 ) \\ {P}_{B} = \frac{1}{4 {sin}^{2} α} + 1 + \frac{sin ϕ}{sin α} & ( 20 )\end{matrix}$$

Application to a principal signal having an omnidirectional directivity pattern:

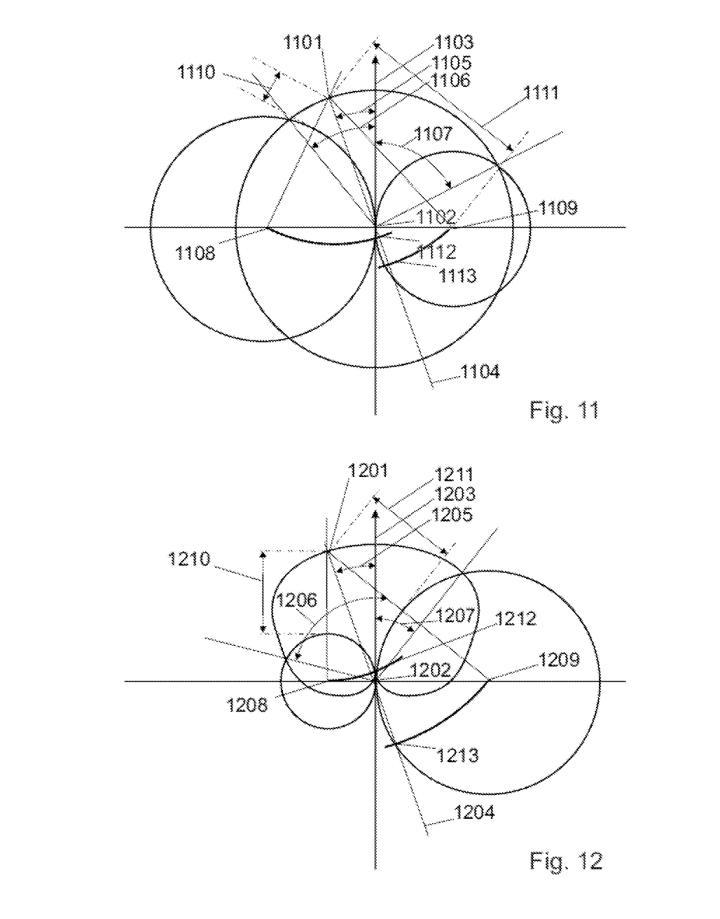

A first example, based on a monophonic audio signal having an omnidirectional directivity pattern, is shown in FIG. 11. In this case, a fictitious opening angle α+β is parameterized, where a is the fictitious left-hand opening angle 1106 (situated to the left of the principal axis of the monophonic audio signal to be stereophonized), β is the fictitious right-hand opening angle 1107 (situated to the right of the principal axis of the monophonic audio signal to be stereophonized)—that is to say angles which cannot arise at all in a classic MS arrangement on account of the use of an S system having a figure-of-eight directivity pattern which has 90-degree rotation to the left and which is symmetrical with respect to the principal axis.

This leads to the consideration regarding the principal axis of the monophonic audio signal to be stereophonized with possibly asymmetric fictitious opening angles α+β.

Considered in detail, the arrangement comprises a sound source 1101 which is recorded by a mono microphone 1102 having an omnidirectional directivity pattern, wherein the microphone principal axis 1103 and the directional axis 1104 of the sound source form the angle φ (1105). Subsequently, a fictitious left-hand opening angle α is parameterized (1106) and also a fictitious right-hand opening angle β (1107), wherein—if the sound source can be classified as being to the left of the principal axis—the relationship φ≦α a must apply or—if the sound source can be classified as being to the right of the principal axis—the relationship φ≦β must apply. Furthermore, in all cases, zero or a region around zero can be ruled out for α and β (since the levels and propagation time differences calculated trigonometrically by parameterizing α and β converge toward infinity, that is to say are technically infeasible).

Alpha, together with the directivity pattern of the principal signal, now determines exactly the geometric positioning 1108 of the simulated left-hand signal S(α), and β, together with the directivity pattern of the principal signal, determine exactly the geometric positioning 1109 of the simulated right-hand signal S(β), which produce the simulated side signal when summed. The propagation time difference L(α) in comparison with the principal signal for the simulated left-hand signal is 1110, and the level P(α) of the simulated signal is ascertained from the level of the principal signal, multiplied by the square of the distance from 1101 and 1112 (level correction taking account of the sound intensity, which decreases as the distance is squared). The propagation time difference L(β) in comparison with the principal signal for the simulated right-hand signal is 1111, and the level P(β) of the simulated signal is ascertained from the level of the principal signal, multiplied by the square of the distance from 1101 and 1113.

Trigonometrically, the following delay times L(α), L(β) and gain factors P(α), P(β) (which, in order to allow unrestricted selection of φ, α and β, can be applied to the signals S(α) and S(β) which produce the simulated side signal S, are accordingly obtained:

$$\begin{matrix}{L}_{α} = - \frac{1}{2 sin α} + \sqrt{\frac{1}{4 {sin}^{2} α} + 1 - \frac{sin ϕ}{sin α}} & ( 21 ) \\ {L}_{β} = - \frac{1}{2 sin β} + \sqrt{\frac{1}{4 {sin}^{2} β} + 1 + \frac{sin ϕ}{sin β}} & ( 22 ) \\ {P}_{α} = \frac{1}{4 {sin}^{2} α} + 1 - \frac{sin ϕ}{sin α} & ( 23 ) \\ {P}_{β} = \frac{1}{4 {sin}^{2} β} + 1 + \frac{sin ϕ}{sin β} & ( 24 )\end{matrix}$$

Application to a principal signal having a cardioid pattern (FIG. 12):

The arrangement under consideration in the present case comprises a sound source 1201, which is recorded by a mono microphone 1202 having a cardioid directivity pattern, wherein the microphone principal axis 1203 and the directional axis 1204 of the sound source form the angle φ (1205). Subsequently, a fictitious left-hand opening angle α is parameterized (1206), and a fictitious right-hand opening angle β (1207), wherein again—if the sound source can be classified as being to the left of the principal axis—the relationship φ≦α must apply or—if the sound source can be classified as being to the right of the principal axis—the relationship φ≦β must apply. Furthermore, in all cases, zero or a region around zero can again be ruled out for α and β (since the levels and propagation time differences trigonometrically calculated by parameterizing α and β likewise converge toward infinity, that is to say are technically infeasible).

α, together with the present directivity pattern for the principal signal, determines exactly the geometric positioning 1208 of the simulated left-hand signal S(α), and β, likewise together with the directivity pattern under consideration here, determines exactly the geometric positioning 1209 of the simulated right-hand signal S(β), which produce the simulated side signal when summed. The propagation time difference L(α) in comparison with the principal signal for the simulated left-hand signal is 1210, and the level P(α) of the simulated signal is ascertained from the level of the principal signal, multiplied by the square of the distance from 1201 and 1212 (level correction taking account of the sound intensity, which decreases as the distance is squared). The propagation time difference L(β) in comparison with the principal signal for the simulated right-hand signal is 1211, and the level P(β) of the simulated signal is ascertained from the level of the principal signal, multiplied by the square of the distance from 1201 and 1213.

Again, the following delay times L(α), L(β) and gain factors P(α), P(β) can be trigonometrically calculated taking account of the polar interval

f(Ψ)=½(1+cos Ψ)

which describes the cardioid directivity pattern of the M signal and which is dependent on the polar angle (wherein the gain factors—in order to allow unrestricted selection of φ, α and β in relation to the directivity pattern—can be applied to the signals S(α) and S(β) which produce the simulated side signal S):

$$\begin{matrix}{L}_{α} = - \frac{( 1 + cos α )}{4 sin α} + \sqrt{\frac{{( 1 + cos α )}^{2}}{16 {sin}^{2} α} + \frac{1}{4} {( 1 + cos ϕ )}^{2} - \frac{( 1 + cos α )}{4 sin α} * ( 1 + cos ϕ ) * sin ϕ} & ( 25 ) \\ {L}_{β} = - \frac{( 1 + cos β )}{4 sin β} + \sqrt{\frac{{( 1 + cos β )}^{2}}{16 {sin}^{2} β} + \frac{1}{4} {( 1 + cos ϕ )}^{2} + \frac{( 1 + cos β )}{4 sin β} * ( 1 + cos ϕ ) * sin ϕ} & ( 26 ) \\ {P}_{α} = \frac{{( 1 + cos α )}^{2}}{16 {sin}^{2} α} + \frac{1}{4} {( 1 + cos ϕ )}^{2} - \frac{( 1 + cos α )}{4 sin α} * ( 1 + cos ϕ ) * sin ϕ & ( 27 ) \\ {P}_{β} = \frac{{( 1 + cos β )}^{2}}{16 {sin}^{2} β} + \frac{1}{4} {( 1 + cos ϕ )}^{2} + \frac{( 1 + cos β )}{4 sin β} * ( 1 + cos ϕ ) * sin ϕ & ( 28 )\end{matrix}$$

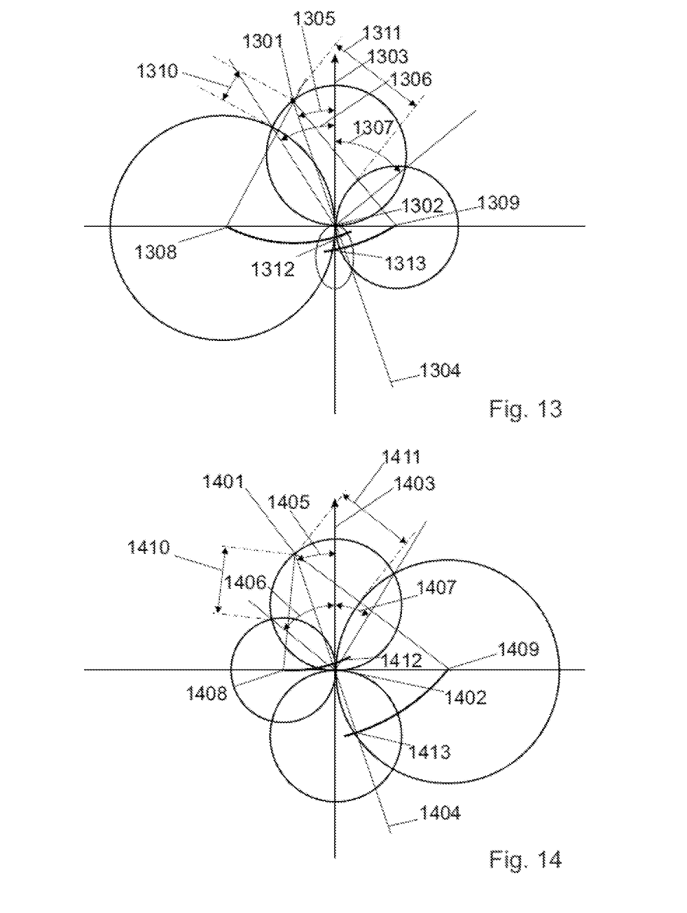

Application to a signal having a hypercardioid pattern (FIG. 13):

The arrangement comprises a sound source 1301 which is recorded by a mono microphone 1302 having a hypercardioid directivity pattern, wherein the microphone principal axis 1303 and the directional axis 1304 of the sound source form the angle φ (1305). Subsequently, a fictitious left-hand opening angle α is again parameterized (1306) and also a fictitious right-hand opening angle β (1307), wherein again—if the sound source can be classified as being to the left of the principal axis—the relationship φ≦α must apply or—if the sound source can be classified as being to the right of the principal axis—the relationship φ≦β must apply. Again, in all cases, zero or a region around zero can be ruled out for α and β (since the levels and propagation time differences trigonometrically calculated by parameterizing α and β converge toward infinity, that is to say are technically infeasible).

α, again together with the hypercardioid pattern of the principal signal, determines exactly the geometric positioning 1308 of the simulated left-hand signal S(α), β, together with the hypercardioid directivity pattern, determines exactly the geometric positioning 1309 of the simulated right-hand signal S(β), which produce the simulated side signal when summed. The propagation time difference L(α) in comparison with the principal signal for the simulated left-hand signal is 1310, and the level P(α) of the simulated signal is ascertained from the level of the principal signal, multiplied by the square of the distance from 1301 and 1312 (level correction taking account of the sound intensity, which decreases as the distance is squared). The propagation time difference L(β) in comparison with the principal signal for the simulated right-hand signal is 1311, and the level P(β) of the simulated signal is ascertained from the level of the principal signal, multiplied by the square of the distance from 1301 and 1313.

The delay times L(α), L(β) and gain factors P(α), P(β) can be (taking account of the polar interval

$$f ( ψ ) = 1 - \frac{n}{2} + \frac{n}{2} * cos ψ , \qquad ( 28 a )$$

(where n assumes the value 1.5), which describes the hypercardioid directivity pattern of the M signal and which is dependent on the polar angle Ψ) trigonometrically calculated (wherein the gain factors—in order to allow unrestricted selection of φ, α and β in relation to the directivity pattern—can be applied to the signals S(α) and S(β), which produce the simulated side signal S):

$$\begin{matrix}{L}_{α} = - \frac{( 1 - \frac{n}{2} + \frac{n}{2} * cos α )}{2 sin α} + \sqrt{\frac{{( 1 - \frac{n}{2} + \frac{n}{2} * cos α )}^{2}}{4 {sin}^{2} α} + {( 1 - \frac{n}{2} + \frac{n}{2} * cos ϕ )}^{2}} \overline{) - \frac{( 1 - \frac{n}{2} + \frac{n}{2} + cos α )}{sin α} * ( 1 - \frac{n}{2} + \frac{n}{2} * cos ϕ ) * sin ϕ} \\ & ( 29 ) \\ {L}_{β} = - \frac{( 1 - \frac{n}{2} + \frac{n}{2} * cos β )}{2 sin β} + \sqrt{\frac{{( 1 - \frac{n}{2} + \frac{n}{2} * cos β )}^{2}}{4 {sin}^{2} β} + {( 1 - \frac{n}{2} + \frac{n}{2} * cos ϕ )}^{2}} \overline{) + \frac{( 1 - \frac{n}{2} + \frac{n}{2} + cos β )}{sin β} * ( 1 - \frac{n}{2} + \frac{n}{2} * cos ϕ ) * sin ϕ} & ( 30 ) \\ {P}_{α} = \frac{{( 1 - \frac{n}{2} + \frac{n}{2} * cos α )}^{2}}{4 {sin}^{2} α} + {( 1 - \frac{n}{2} + \frac{n}{2} * cos ϕ )}^{2} - \frac{( 1 - \frac{n}{2} + \frac{n}{2} * cos α )}{sin α} * ( 1 - \frac{n}{2} + \frac{n}{2} * cos ϕ ) * sin ϕ & ( 31 ) \\ {P}_{β} = \frac{{( 1 - \frac{n}{2} + \frac{n}{2} * cos β )}^{2}}{4 {sin }^{2} β} + {( 1 - \frac{n}{2} + \frac{n}{2} * cos ϕ )}^{2} + \frac{( 1 - \frac{n}{2} + \frac{n}{2} * cos β )}{sin β} * ( 1 - \frac{n}{2} + \frac{n}{2} * cos ϕ ) * sin ϕ & ( 32 )\end{matrix}$$

Application to signals having further special forms of a cardioid pattern:

If the input signal to be stereophonized has special forms of the cardioid pattern, the relevant propagation time differences L(α) and L(β) and gain factors P(α) and P(β) can easily be calculated from formulae (29) to (32). In this case, the following applies for n: 0≦n≦2.

If n assumes the value 1, the gain factors and propagation time differences for an input signal having a classic cardioid directivity pattern are obtained, for the value 0 the gain factors and propagation time differences for an input signal having an omnidirectional directivity pattern are obtained, for the value 2 the gain factors and propagation time differences for an input signal having a classic figure-of-eight directivity pattern are obtained. If n assumes the value 1.25, the propagation time differences and gain factors for an input signal having a supercardioid pattern are obtained.

The application of formula (28a) to the polar interval f, resulting in the set of formulae (29) to (32), is accordingly found to be particularly favorable. Only the parameter n needs to be stipulated in order to describe almost all possible directivity patterns for the M expressed in polar coordinates (apart from the shotgun pattern, which, as frequency rises, increasingly has polar coordinates other than (28a) is able to represent).

Application to a signal having a figure-of-eight pattern:

FIG. 14 again shows a detailed illustration of the instance of application for an input signal having a figure-of-eight directivity pattern, which has already been discussed more than once above. The arrangement comprises a sound source 1401 which is recorded by a mono microphone 1402 having a figure-of-eight directivity pattern, wherein the microphone principal axis 1403 and the directional axis 1404 of the sound source form the angle φ (1405). A fictitious left-hand opening angle α is parameterized (1406) and also a fictitious right-hand opening angle β (1407), wherein again—if the sound source can be classified as being to the left of the principal axis—the relationship φ≦α must apply or—if the sound source can be classified as being to the right of the principal axis—the relationship φ≦β must apply. Subsequently, in all cases, zero or a region around zero can likewise be ruled out for α and β (since the levels and propagation time differences trigonometrically calculated by parameterizing α and β likewise converge toward infinity, that is to say are technically infeasible).

α, together with the figure-of-eight directivity pattern of the principal signal, determines exactly the geometric positioning 1408 of the simulated left-hand signal S(α), and β, together with the figure-of-eight directivity pattern, determines exactly the geometric positioning 1409 of the simulated right-hand signal S(β), which produce the simulated side signal when summed. The propagation time difference L(α) in comparison with the principal signal for the simulated left-hand signal is 1410, and the level P(α) of the simulated signal is ascertained from the level of the principal signal, multiplied by the square of the distance from 1401 and 1412 (level correction taking account of the sound intensity, which decreases as the distance is squared). The propagation time difference L(β) in comparison with the principal signal for the simulated right-hand signal is 1411, and the level P(β) of the simulated signal is ascertained from the level of the principal signal, multiplied by the square of the distance from 1401 and 1413. The associated set of formulae for the delay times L(α), L(β) and the gain factors P(α), P(β) can be taken from equations (7) to (10), and from equations (29) to (32), if n is equal to 2 (where the gain factors—in order to allow unrestricted selection of φ, α and β in relation to the directivity pattern—can be applied to the signals S(α) and S(β) which produce the simulated side signal S).

Application to a circuit for stereophonizing a mono signal:

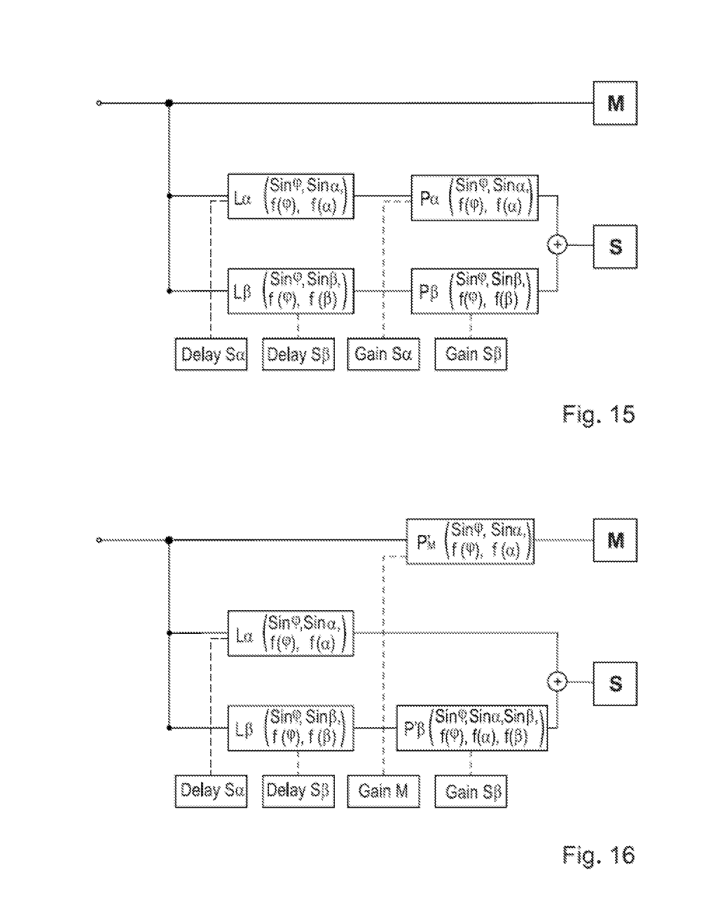

FIG. 15 shows a circuit which generalizes the directivity pattern of the input signal and which takes account of the recording angle φ, of a left-hand fictitious opening angle α, of a right-hand fictitious opening angle β and of an angle-dependent polar interval f describing the directivity pattern of the M signal in order to convert a monophonic audio signal into MS signals which can be stereophonized. In this case, formulae (3) to (6) can be used for the propagation time differences L(α) and L(β) and the gain factors P(α) and P(β). The input signal is used directly as the M signal in this case. The S signal is added up from the input signal delayed by the delay time L(α), which input signal is subsequently amplified by the gain factor P(α), and a further signal which represents the input signal delayed by the delay time L(β), subsequently amplified by the gain factor P(β). Again, the relationship φ≦α must apply—if φ≦0—or the relationship |φ|≦β must apply—if φ≦0. Similarly, in all cases, zero or a region around zero can be ruled out for α and β (since the levels and propagation time differences trigonometrically calculated by parameterizing α and β converge toward infinity, that is to say are technically infeasible).

Derivations of circuits which deliver equivalent signals under slight restrictions:

FIG. 15 can be used to infer a slightly restrictedly operating circuit of the form in FIG. 16 when the gain factors are reweighted. In this case, the restriction is the condition that for the recording angle φ, the left-hand fictitious opening angle α and the angle-dependent polar interval f describing the directivity pattern of the M signal it must be true that the expression

$$\frac{{f}^{2} ( α )}{4 {sin}^{2} α} + {f}^{2} ( ϕ ) - \frac{f ( α )}{sin α} * f ( ϕ ) * sin ϕ \qquad ( 33 )$$

is not equal to zero or an element of a region around zero. The propagation time differences L(α) and L(β) cited in FIG. 16 directly represent equations (3) and (4) in this case; for the gain factors P_{M′}, and P(β)′, the relationships

$$\begin{matrix}{P}_{M}^{‵} = \frac{1}{\frac{{f}^{2} ( α )}{4 {sin}^{2} α} + {f}^{2} ( ϕ ) - \frac{f ( α )}{sin α} * f ( ϕ ) * sin ϕ} & ( 34 ) \\ {P}_{β}^{‵} = \frac{\frac{{f}^{2} ( β )}{4 {sin}^{2} β} + {f}^{2} ( ϕ ) + \frac{f ( β )}{sin β} * f ( ϕ ) * sin ϕ}{\frac{{f}^{2} ( α )}{4 {sin}^{2} α} + {f}^{2} ( ϕ ) - \frac{f ( α )}{sin α} * f ( ϕ ) * sin ϕ} & ( 35 )\end{matrix}$$

apply.

In addition, the relationship φ≦α must apply—if φ≦0—or the relationship |φ|≦β must apply—if φ≦0. Again, in all cases, zero or a region around zero can be ruled out for α and β (since the levels and propagation time differences trigonometrically calculated by parameterizing α and β converge to some extent toward infinity, that is to say are technically infeasible).

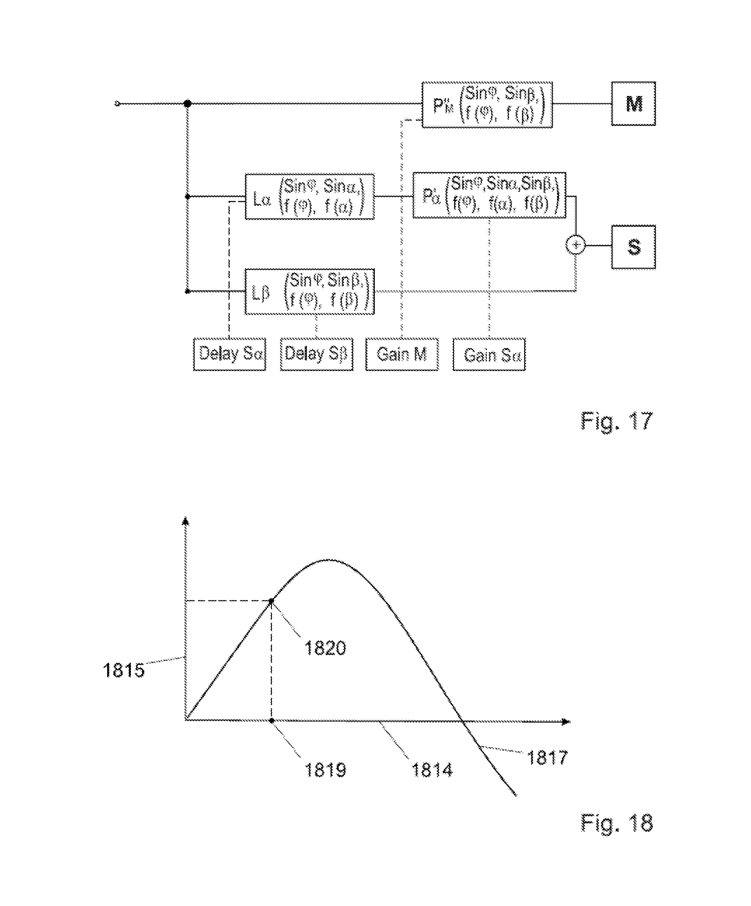

A second derivation from FIG. 15 given a change in the reweighting of the gain factors produces a likewise slightly restrictedly operating circuit in the form from FIG. 17, wherein it must be true for the recording angle φ, the right-hand fictitious opening angle β and the angle-dependent polar interval f describing the directivity pattern of the M signal that the expression

$$\frac{{f}^{2} ( β )}{4 {sin}^{2} β} + {f}^{2} ( ϕ ) + \frac{f ( β )}{sin β} * f ( ϕ ) * sin ϕ \qquad ( 36 )$$

is not equal to zero or an element of a region around zero. The propagation time differences L(α) and L(β) cited in FIG. 17 are again equations (3) and (4) in this case; for the gain factors P_{M′}, and P(α)′, however, the relationships

$$\begin{matrix}{P}_{M}^{``} = \frac{1}{\frac{{f}^{2} ( β )}{4 {sin}^{2} β} + {f}^{2} ( ϕ ) + \frac{f ( β )}{sin β} * f ( ϕ ) * sin ϕ} & ( 37 ) \\ {P}_{α}^{‵} = \frac{\frac{{f}^{2} ( α )}{4 {sin}^{2} α} + {f}^{2} ( ϕ ) - \frac{f ( α )}{sin α} * f ( ϕ ) * sin ϕ}{\frac{{f}^{2} ( β )}{4 {sin}^{2} β} + {f}^{2} ( ϕ ) + \frac{f ( β )}{sin β} * f ( ϕ ) * sin ϕ} & ( 38 )\end{matrix}$$

now apply.

Again, the relationship φ≦α must apply—if φ≦0—or the relationship |φ|≦β must apply—if φ<0. Similarly, in all cases, zero or a region around zero can be ruled out for α and β (since the levels and propagation time differences trigonometrically calculated by parameterizing α and β converge to some extent toward infinity, that is to say are technically infeasible).

Application to a computation method for stereophonizing a mono signal:

A monophonic input signal can be arithmetically represented using a coordinate system in the form in FIG. 18, where 1814 is the time axis and 1815 is the level axis. 1819 is the time and 1820 is the level point Pᵢ(tᵢ) correlated to tᵢ. For sufficiently small intervals [tᵢ, tᵢ₊₁], that is to say a sufficient sampling rate, it is now possible to depict the sound event with sufficient accuracy.

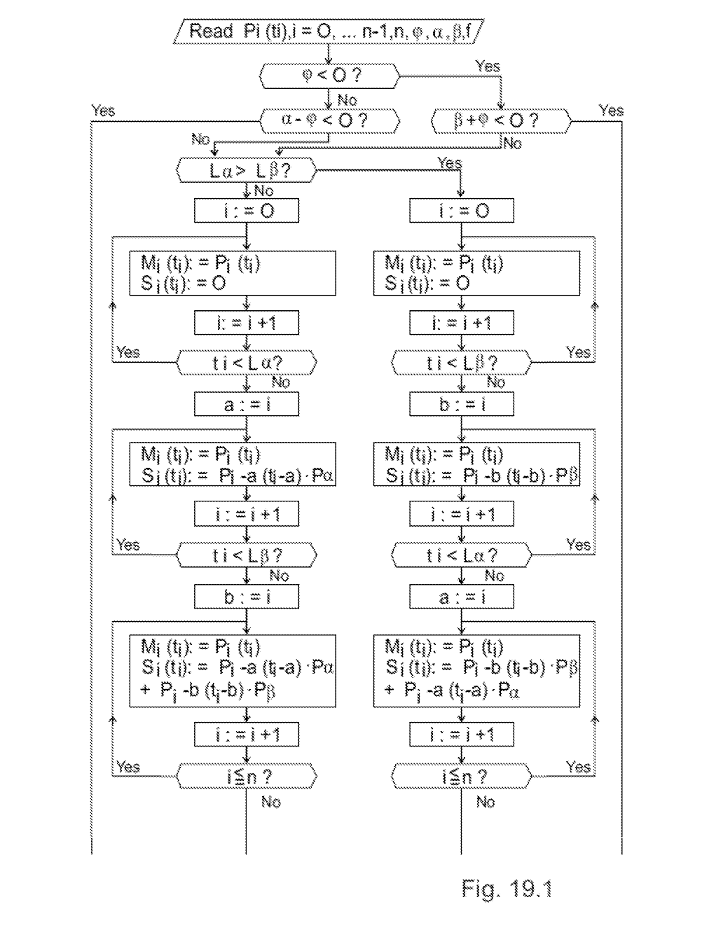

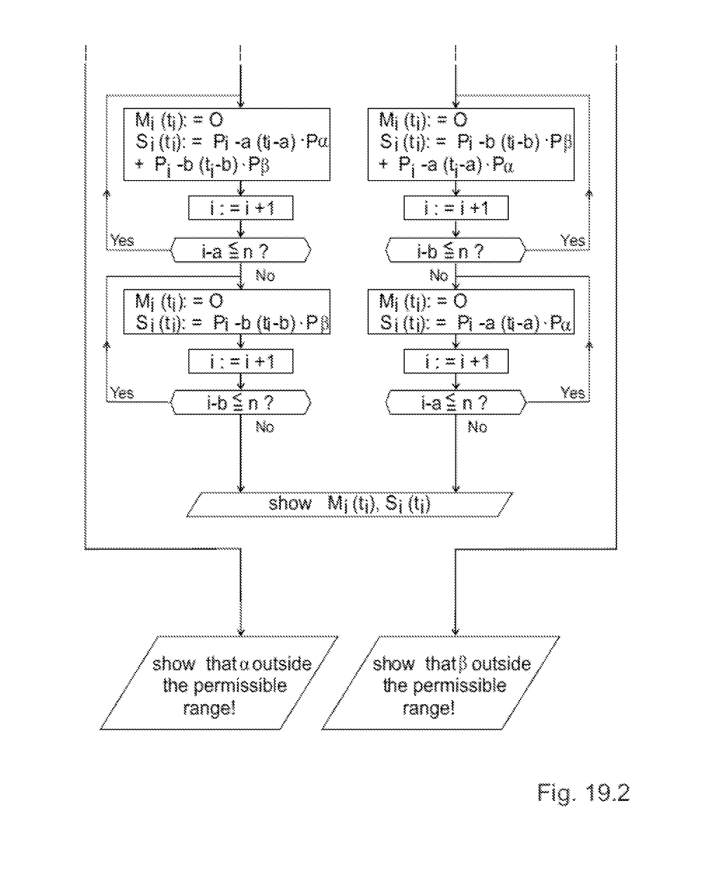

FIG. 19 shows the associated flowchart for a method which takes account of the recording angle φ, of a left-hand fictitious opening angle α, of a right-hand fictitious opening angle β and of an angle-dependent polar interval f describing the directivity pattern of the M signal, given sufficiently small intervals [tᵢ, tᵢ₊₁], in order to convert a monophonic audio signal into MS signals which can be stereophonized (under the simplifying assumption that the propagation time difference L(α) or the propagation time difference L(β) remains unequal to zero).

For the propagation time differences L(α) and L(β) and the gain factors P(α) and P(β), equations (3) to (6) again subsequently apply.

An M signal (the array [Mᵢ(tᵢ)]) and an S signal (the array [Sᵢ(tᵢ)]), which is actually added up from the input signal delayed by the delay time L(α), which input signal is subsequently amplified by the gain factor P(α), and a further signal, which is the input signal actually delayed by the delay time L(β), subsequently amplified by the gain factor P(β). The algorithm rules out inadmissible values of α and β. In general, the relationship φ≦α must apply for such algorithms—if φ>0—or the relationship |φ|≦β must apply—if φ<0. Similarly, in all cases, zero or a region around zero can be ruled out for α and β (since the levels and propagation time differences trigonometrically calculated by parameterizing α and β converge toward infinity, that is to say are technically infeasible).

Derivations of two computation methods which deliver equivalent signals under slight restrictions:

Method 1: If it remains algorithmically assured that (33) is not equal to zero or an element of a region around zero, a computation method similar to FIG. 19 can be applied to a monophonic input signal for sufficiently small intervals [tᵢ, tᵢ₊₁] in a manner shown in FIG. 16, but with the M signal (the array [Mᵢ(tᵢ)]) now appearing amplified by the factor (34). The S signal (the array [Sᵢ(tᵢ)]) is the result of the addition of the input signal (the array [Pᵢ(tᵢ)]) actually delayed by the delay time L(α) (see formula (3)) to the input signal (again the array [Pᵢ(tᵢ)]) actually delayed by the delay time L(β) (see formula (4)) and then amplified by the factor P(β)′ (see formula (35)). The algorithm must rule out inadmissible values of a and the relationship φ≦α must apply—if φ>0—or the relationship |φ|≦β must apply—if φ<0. Similarly, in all cases, zero or a region around zero can be ruled out for α and β (since the levels and propagation time differences trigonometrically calculated by parameterizing α and β converge to some extent toward infinity, that is to say remain technically infeasible).

Method 2: If it remains algorithmically assured that (36) is not equal to zero or an element of a region around zero, a computation method similar to FIG. 19 can likewise be applied to a monophonic input signal for sufficiently small intervals [tᵢ, tᵢ₊₁] in the manner of FIG. 17, with the M signal (the array [Mᵢ(tᵢ)]) now appearing amplified by the factor (37). The S signal (the array [Sᵢ(tᵢ)]) is the result of the addition of the input signal (the array [Pᵢ(tᵢ)]) actually delayed by the delay time L(α) (see formula (3)) and subsequently amplified by the gain factor P(α)′ (see formula (38)) to the input signal (again the array [Pᵢ(tᵢ)]) actually delayed by the delay time L(β) (see formula (4)). The algorithm must rule out inadmissible values of α and β. The relationship φ≦α must apply—if φ≦0—or the relationship |φ|≦β must apply—if φ<0. Similarly, in all cases, zero or a region around zero can be ruled out for α and β (since the levels and propagation time differences trigonometrically calculated by parameterizing α and β converge to some extent toward infinity, that is to say remain technically infeasible).

Observed overall, the apparatuses and methods described naturally also permit the amplification of the respective input signal before a subsequent delay is executed.

### EXAMPLES OF AREAS OF APPLICATION FOR THE INVENTION

The spatial breakdown of a sound source recorded at a particular angle φ has great practical significance particularly for telephone signals. In the case of hands-free devices, such as are used in automobiles or for internet telephony, the monophonic signal emitted is perceived as not corresponding to the real call situation; the opposite appears “omnipresent”. If, however, metrological methods associated with the prior art are used to ascertain the angle φ or to functionally interpolate the polar coordinates (possible by virtue of algorithmic consideration of the maxima and minima in the polar diagram of the input signal), and if the fictitious left-hand opening angle α and the fictitious right-hand opening angle β are subsequently matched algorithmically or manually to the recording and listening situation, it is possible to use a (miniaturizable!) circuit in the form in FIG. 15, for example, to attain a stereophonic signal, during final MS matrixing, which takes much greater account of a call situation under natural conditions.

The procedure may be similar with monophonic sound recordings in which sound sources need to be reproduced stereophonically.

Similarly, if the direction of depiction of a sound source—insulated by means of signal processing—within a stereo image is perceived as being too acute, the direction of depiction can be gradually dispersed by applying the subject matter of the invention.

The shaping of the directivity pattern of the input signal (possible point by point by varying the polar coordinates which describe the directivity pattern of the input signal, comprehensively possible, by way of example, by means of the application—associated with the prior art—of comb filters in conjunction with methods based on fast Fourier transformation (FFT)) before it passes through an arrangement or a method in accordance with the subject matter of the invention can sometimes improve the result further or ensure that the directivity pattern of the input signal is normalized.

The invention can achieve an overall significant contribution to the retrospective multidimensional consideration of signal paths. The application thereof is therefore not limited to the examples above.

1. An apparatus for stereophonizing a mono signal, comprising
a converter for converting the mono signal into a principal signal and a side signal by delaying and amplifying the mono signal on the basis of an angle φ between sound source and microphone principal axis.

2. Apparatus according to claim 1, wherein the converter is configured to convert the mono signal into a principal signal and a side signal by delaying and amplifying the mono signal on the basis of an opening angle α, which adjoins the microphone principal axis on one side.

3. Apparatus according to claim 2, wherein the convener is configured to convert the mono signal into a principal signal and a side signal by delaying and amplifying the mono signal on the basis of an further opening angle β, which adjoins the microphone principal axis on another side.

4. Apparatus according to claim 3, wherein the opening angle α and the further opening angle βare equal.

5. Apparatus according to claim 1, wherein the converter is configured to convert the mono signal into a principal signal and a side signal by delaying and amplifying the mono signal on the basis of a directivity pattern of the mono signal.

6. Apparatus according to claim 1, wherein the converter is configured to convert the mono signal into a principal signal and a side signal by delaying and amplifying the mono signal on the basis of an opening angle α, which adjoins the microphone principal axis on the left, an further opening angle β, which adjoins the microphone principal axis on the right and a directivity pattern of the mono signal.

7. Apparatus according to claim 6, wherein the angle α is zero, and the opening angle α and the further opening angle β are equal.

8. Apparatus according to claim 1, wherein the angle φ is zero.

9. Apparatus according to claim 1, wherein the angle φ is constant.

10. Apparatus according to claim 1, wherein the converter comprises:
a first delayer for delaying the mono signal by a first delay time dependent on an angle φ between sound source and microphone principal axis;
a first amplifier for amplifying the mono signal by a first gain dependent on the angle φ,
wherein the converter is configured to create the side signal on the basis of the mono signal delayed by the first delayer and amplified by the first amplifier.

11. Apparatus according to claim 10, wherein the first delay time and the first gain depend further on at least one of an opening angle α, which adjoins the microphone principal axis on one side, a further opening angle β, which adjoins the microphone principal axis on another side and a directivity pattern of the mono signal.

12. Apparatus according to claim 11, wherein the first delay time and the first gain depend on the opening angle α and the further opening angle β, wherein the angle φ is zero and the opening angle α is equal to the further opening angle β.

13. Apparatus according to claim 12, wherein the converter comprises further a second amplifier for amplifying the mono signal by a second gain dependent on the angle φ, wherein the converter is configured to create the principal signal on the basis of the mono signal amplified by the second amplifier.

14. Apparatus according to claim 10, wherein the converter comprises further a second delayer for delaying the mono signal by a second delay time depending on the angle φ and an adder for adding the mono signal delayed by the second delayer to the mono signal delayed by the first delayer and amplified by the first amplifier, wherein the converter is configured to create the side signal on the basis of the added signal output from the adder.

15. Apparatus according to claim 14, wherein the first delay time, the first gain and the second delay time depend further on at least one of an opening angle α, which adjoins the microphone principal axis on one side, an further opening angle β, which adjoins the microphone principal axis on another side and/or a directivity pattern of the mono signal

16. Apparatus according to claim 14, wherein the converter comprises further a second amplifier for amplifying the mono signal by a second gain dependent on the angle φ, wherein the converter is configured either
to create the principal signal on the basis of the mono signal amplified by the second amplifier or
to create the side signal on the basis of the added signal, wherein the adder is configured to add the mono signal delayed by the second delayer and amplified by the second amplifier to the mono signal delayed by the first delayer and amplified by the first amplifier.

17. Apparatus according to claim 1 comprising a further converter for converting the principal signal and the side signal into a stereo signal.

18. Apparatus according to claim 1 comprising input means for reading the mono signal and the angle φ.

19. Apparatus according to claim 6 comprising input means for reading the mono signal and at least one of the angle φ, the opening angle α, the further opening angle β and/or a directivity pattern of the mono signal.

20. Apparatus according to claim 1, wherein the angle φ is matched to a recording or listening situation.

21. Apparatus according to claim 6, wherein at least one of the angle φ, the opening angle α, the further opening angle β and/or the directivity pattern of the mono signal are matched to a recording or a listening situation.

22. A method for stereophonizing a mono signal, comprising the step of converting the mono signal into a principal signal and a side signal by delaying and amplifying the mono signal on the basis of an angle φ between sound source and microphone principal axis.

23. Apparatus for stereophonizing a mono signal, comprising
input means for reading parameters for determining a delay time and a gain;
a converter for converting the mono signal into a principal signal and a side signal by delaying and amplifying the mono signal on the basis of the determined delay and gain.
